(19) United States
(12) Patent Application Publication
(10) Pub. No.: US 2026/0321564 A1
(43) Pub. Date: Oct. 15, 2026

(54) ANALYSIS WORK SUPPORT PROGRAM FOR LASER DESORPTION IONIZATION MASS SPECTROMETER AND SAMPLE PREPARATION METHOD USING SAID PROGRAM

(71) Applicant: SHIMADZU CORPORATION, Kyoto (JP)

(72) Inventors: Nanami MINAMI SAKASHITA, Kyoto-shi (JP); Shinji Funatsu, Kyoto-shi (JP)

(73) Assignee: SHIMADZU CORPORATION, Kyoto (JP)

(21) Appl. No.: 19/635,843

(22) Filed: Apr. 1, 2026

(30) Foreign Application Priority Data
Apr. 1, 2025 (JP) 2025-060805

(51) Int. Cl. H01J 49/04; H01J 49/00; H01J 49/16

(52) U.S. Cl. CPC H01J 49/0418; H01J 49/0031; H01J 49/164

(57) ABSTRACT

One aspect of an analysis work support program according to the present invention is a program for supporting registration of information regarding samples upon analysis in an LDI-MS capable of sequentially executing analysis on samples prepared in advance in a plurality of wells on a plate, the program causing a computer to function as: a well presentation function unit (200) that presents the plurality of wells on the plate one by one to an operator in a prescribed order; an information acquisition function unit (201) that, in a state where one well is presented, receives sample information obtained by a reading operation using a reading device (4) by the operator with respect to an identifier that has sample information including information indicating a sample type for one sample and information for identifying the sample under the sample type or that is associated with the sample information; and an information registration function unit (202) that registers the received sample information in association with identification information of the well that was being presented when the reading operation was performed.

### TECHNICAL FIELD

The present invention relates to a computer program for supporting analysis work in a laser desorption ionization mass spectrometer, including a matrix-assisted laser desorption/ionization mass spectrometer (hereinafter referred to as “MALDI-MS”), and a method for preparing a sample for analysis with a laser desorption ionization mass spectrometer using said program.

### BACKGROUND ART

When performing analysis with MALDI-MS, generally, a matrix solution as an ionization auxiliary agent is added to a sample to be analyzed, and a small amount of the liquid is dropped into a well on a dedicated sample plate and air-dried to form a sample. In MALDI-MS, the sample on the sample plate thus formed is irradiated with laser light to ionize compounds in the sample, and mass spectrometry is performed on the generated ions.

Usually, prior to the analysis of a target sample to be analyzed, an analysis of a calibrant prepared from a standard sample for calibration is performed, and the results of the analysis are used to calibrate m/z (mass-to-charge ratio) values. In addition, particularly in fields where high reliability is required, such as pharmaceutical-related fields and food fields, a QC (Quality Control) sample for quality control containing a known component at a known concentration is analyzed every time a predetermined number of target samples are analyzed, or at the start and end of a series of analyses for a plurality of target samples, and work for evaluating whether or not the analysis of the target samples has been appropriately performed is carried out using the analysis results (see Patent Document 2, etc.).

Accordingly, in addition to the target sample, different types of samples such as calibrants and QC samples can be formed on the sample plate.

When executing analysis or analyzing data based on analysis results, and further when managing such analysis results and analysis results, sample information is required, which includes information indicating what type (for example, target sample, QC sample, calibrant, etc.) the sample formed on the sample plate is, or information indicating what kind of sample it is (for example, if it is a calibrant, information indicating what compound is included; if it is a target sample, information such as a sample name or an identification number that can identify each sample). Therefore, the work of an operator inputting sample information for each sample formed or to be formed on a sample plate is usually performed prior to the execution of analysis, for example, at the time of sample formation.

### PRIOR ART DOCUMENTS

### Patent Documents

[Patent Document 1] Japanese Patent Laid-Open No. 2019-74441
[Patent Document 2] International Publication No. WO 2022/049811

### SUMMARY OF THE INVENTION

### Problems to be Solved by the Invention

Patent Document 1 describes an example of a sample plate for MALDI-MS. The sample plate exemplified in said document has a plurality of normal wells on the sample plate, in each of which a sample is formed, and separately from the normal sample wells, has dedicated calibrant wells. Specifically, one dedicated calibrant well is arranged for every 16 sample wells. Thus, by providing dedicated calibrant wells separately from normal wells, it is possible to reduce the occurrence of errors in the linking between samples on the plate and sample information caused by mistakes in the formation position of the calibrant and the target sample due to an operator's work error or the like, or input errors in sample information corresponding to each well including those for calibrants.

However, since the type of calibrant used differs depending on analysis conditions such as the m/z range to be measured, depending on the number of target samples to be analyzed under the same analysis conditions, the sample plate is subjected to analysis in a state where target samples are not mounted in some of the normal wells, that is, in a state where some of the wells are not used. An increase in unused wells means a decrease in the number of target samples that can be analyzed with the same number of sample plates. In other words, if the position of the usable wells is determined for each sample type, the number of sample plates required to analyze the same number of target samples may increase, leading to an increase in the running costs of analysis, the operator's work, and work time.

On the other hand, Patent Document 2 describes, in addition to a method of predetermining positions of wells for forming QC samples on a sample plate, a method in which an operator can freely set the positions of the wells. When the positions of usable wells can be appropriately determined without fixing them for each sample type in this way, the operator needs to perform an operation of inputting information indicating the type of sample to be formed in the well for each well on the sample plate, and then perform an operation of setting information for identifying the sample in that type. Performing such multi-step operations for each sample is complicated, which reduces workability and also causes work errors.

The present invention has been made to solve such problems, and its main object is to provide an analysis work support program for a laser desorption ionization mass spectrometer and a sample preparation method using the program, which can ensure accuracy in the correspondence between samples formed in wells and sample information while increasing the degree of freedom in using wells on a sample plate, and further improve workability in inputting sample information.

### Means for Solving the Problems

One aspect of the analysis work support program for a laser desorption ionization mass spectrometer according to the present invention is a program for supporting registration of information regarding samples upon analysis in a laser desorption ionization mass spectrometer capable of sequentially executing analysis on samples prepared in advance in a plurality of wells on a sample plate, the program causing a computer to function as: a well presentation function unit that presents the plurality of wells on the sample plate one by one to an operator in a prescribed order;
an information acquisition function unit that, in a state where one well is presented by the well presentation function unit, receives sample information obtained by a reading operation using a reading device by the operator with respect to an identifier that has sample information including information indicating a sample type for one sample and information for identifying the sample under the sample type or that is associated with the sample information; and
an information registration function unit that registers the sample information received by the information acquisition function unit in association with identification information of the well that was being presented when the reading operation was performed.

One aspect of the sample preparation method according to the present invention is a method for preparing a sample using the analysis work support program for a laser desorption ionization mass spectrometer according to the above aspect, the method executing:
an identifier reading step in which the operator performs a reading operation to read an identifier that has sample information for one sample or is associated with the sample information using a reading device according to the position of the well presented by the well presentation function unit;
an information registration step of registering the sample information included in or associated with the identifier read in the identifier reading step in association with identification information of the well that was being presented when the reading operation was performed; and
a sample formation step of forming a sample corresponding to the sample information in the well on the sample plate where the sample information has been registered in the information registration step.

### Effects of the Invention

According to the present invention, a well at an arbitrary position among a plurality of wells on a sample plate can be used as a well for forming not only a target sample but also other types of samples such as, for example, a calibrant or a quality control sample. Therefore, on the sample plate, the degree of freedom in the positions of wells for respectively forming the target sample, the calibrant, the quality control sample, and the like increases, and it becomes possible to effectively utilize the wells on the sample plate. Thereby, the sample plate can be utilized without waste, and running costs for analysis can be saved.

Further, according to the present invention, the work of inputting sample information including information indicating the type of sample and information for identifying the sample is simplified. Furthermore, regardless of differences in sample types such as, for example, target samples, calibrants, and quality control samples, the input work for registering sample information can be performed with operations of the same procedure. Thereby, the workability of sample information registration and sample preparation is improved, and the occurrence of work errors such as input errors of sample information is reduced, so that accuracy in the correspondence between actual samples formed in wells and sample information can be ensured. As a result, the reliability of analysis can also be improved.

### BRIEF DESCRIPTION OF THE DRAWINGS

FIG. 1 is a schematic block configuration diagram of one embodiment of a MALDI-MS system using an analysis work support program according to the present invention.

FIG. 2 is an example of a flowchart showing a procedure and process of sample preparation work in the MALDI-MS system of the present embodiment.

FIG. 3 is a plan view showing an example of a sample plate used in the MALDI-MS system of the present embodiment.

FIG. 4 is a diagram showing an example of a display screen during sample preparation in the MALDI-MS system of the present embodiment.

FIG. 5 is a diagram showing an example of a sample information registration result for each sample plate in the MALDI-MS system of the present embodiment.

### DESCRIPTION OF EMBODIMENTS

Hereinafter, an embodiment of a MALDI-MS system using an analysis work support program for a laser desorption ionization mass spectrometer according to the present invention will be described with reference to the accompanying drawings. In this MALDI-MS system, a barcode is used as an identifier that has sample information or is associated with sample information. However, usable identifiers are not limited to barcodes, and as described later, any identifier may be used as long as information can be read using some kind of reading device.

In the following description, a target sample to be analyzed, a QC sample for quality control, and a calibrant for mass calibration, which are formed in wells on a sample plate, may be collectively referred to as a sample.

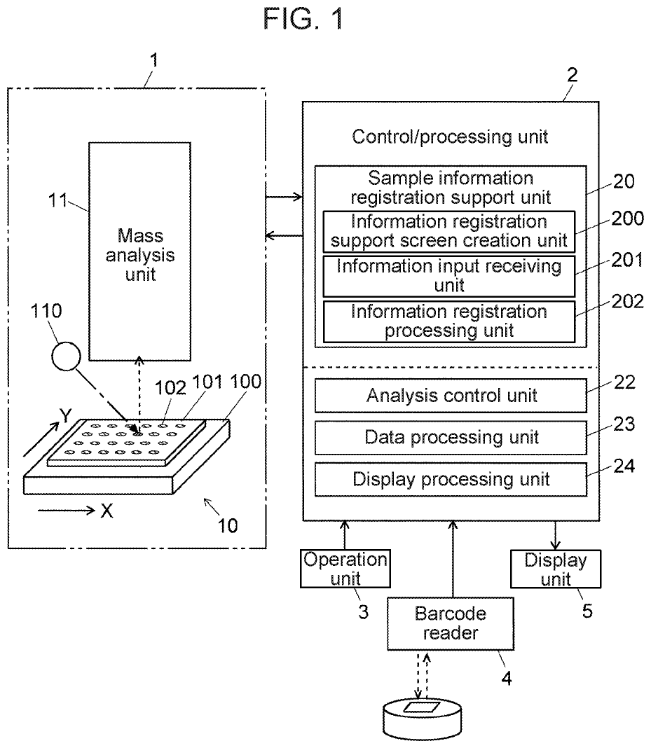

FIG. 1 is a schematic block configuration diagram of the MALDI-MS system of the present embodiment. This MALDI-MS system includes a measurement unit 1, a control/processing unit 2, an operation unit 3, a barcode reader 4 which is an identifier reading device, and a display unit 5.

The measurement unit 1 includes a MALDI ion source 10 and a mass analysis unit 11. The MALDI ion source 10 includes a sample stage 100 for holding a sample plate 101, and a laser irradiation unit 110 for irradiating a sample formed in a well 102 on the sample plate 101 with laser light for ionization. The sample stage 100 is movable in two axial directions, the X-axis and Y-axis, which are orthogonal to each other, by a stage drive mechanism (not shown). The mass analysis unit 11 includes an appropriate type of mass analyzer such as, for example, a time-of-flight mass analyzer or an ion trap mass analyzer, and an ion detector.

The control/processing unit 2 includes, as functional blocks, a sample information registration support unit 20, an analysis control unit 22, a data processing unit 23, and a display processing unit 24. The sample information registration support unit 20 includes, as lower blocks, an information registration support screen creation unit 200, an information input receiving unit 201, and an information registration processing unit 202.

The substance of the control/processing unit 2 is a computer such as a personal computer or a workstation, and the above functional blocks are embodied by executing one or more dedicated software (computer programs) installed in such a computer on the computer. Such a computer program can be stored in a computer-readable non-transitory recording medium such as a CD-ROM, DVD-ROM, memory card, or USB memory (dongle) and provided to a user. Alternatively, it can be provided to the user in the form of data transfer via a communication line such as the Internet. Alternatively, it can be pre-installed in a computer that is part of the system at the time the user purchases the system.

Note that in FIG. 1, the sample information registration support unit 20 is included in the control/processing unit 2, but as will be described later, the function of the sample information registration support unit 20 is used during sample preparation, and actual analysis only requires the information registered by the sample information registration support unit 20. Therefore, the sample information registration support unit 20 does not have to be included in the control/processing unit 2. That is, the sample information registration support unit 20 may be a function embodied by software mounted on a computer different from the control/processing unit 2.

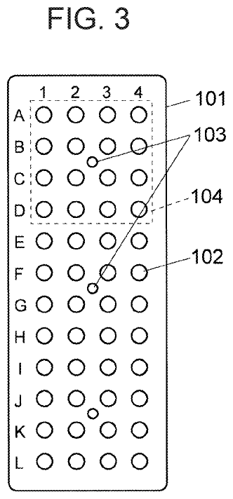

FIG. 3 is a plan view showing an example of the sample plate used here. In this example, the sample plate 101 is formed with wells 102 having a circular shape in a plan view in a matrix of 12×4 (48 in total). Further, at appropriate positions between the wells 102, dedicated calibrant wells 103, which are one size smaller than the wells 102, are formed. The dedicated calibrant well 103 is a dedicated well for mounting a standard sample for mass calibration or the like. Here, one dedicated calibrant well 103 is provided for 16 wells 102 in the range shown by the dotted line 104 in FIG. 3.

In analysis using a conventional MALDI-MS, a calibrant is formed in the dedicated calibrant well 103, and a target sample and a QC sample are formed in the wells 102. In contrast, in analysis using the MALDI-MS system of the present embodiment, a calibrant, a target sample, or a QC sample can be formed in a plurality of wells 102 on the sample plate 101. That is, in the sample plate used in the MALDI-MS system of this embodiment, the dedicated calibrant well 103 is not necessarily required.

First, the analysis operation in the MALDI-MS system of the present embodiment will be briefly described with reference to FIG. 1.

Under the control of the analysis control unit 22, the sample stage 100 is driven by the stage drive mechanism so that the sample to be analyzed formed in a predetermined well 102 on the sample plate 101 comes to a laser light irradiation position. The laser light emitted from the laser irradiation unit 110 hits the sample, and compounds contained in the sample are ionized. The generated ions are introduced into the mass analysis unit 11, and the ions are separated according to m/z values and detected. In the mass analysis unit 11, for example, spectral data indicating the intensity of ions in a predetermined m/z range is obtained. This data is input to the data processing unit 23, the data processing unit 23 creates a mass spectrum, and the display processing unit 24 displays the mass spectrum on the screen of the display unit 5. Further, the data processing unit 23 performs identification (qualitative analysis), quantification, or structural analysis of the compounds based on the mass spectrum.

In the MALDI-MS system of the present embodiment, the mass spectrometry operation as described above for a plurality of samples formed on the sample plate 101 can be performed sequentially for each sample. At that time, the mass spectrometry result for the calibrant is used for calibration of m/z values, and the mass spectrometry result for the QC sample is used for evaluation and determination of suitability, etc., of mass spectrometry for the target sample.

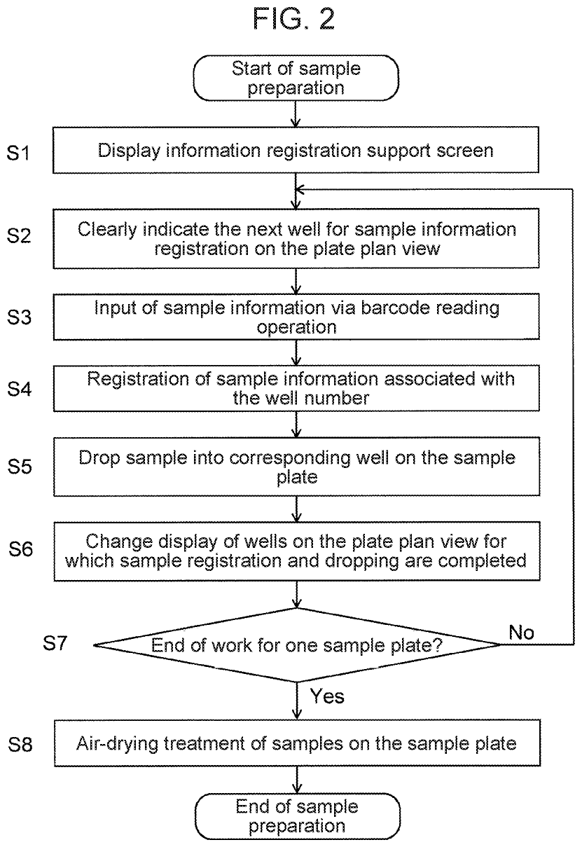

Next, sample preparation work including sample information registration work, which is performed prior to the execution of analysis as described above in the MALDI-MS system of the present embodiment, will be described. This sample preparation work is performed before the sample plate 101 is set in the measurement unit 1. FIG. 2 is a flowchart showing an example of the procedure and process of the sample preparation work.

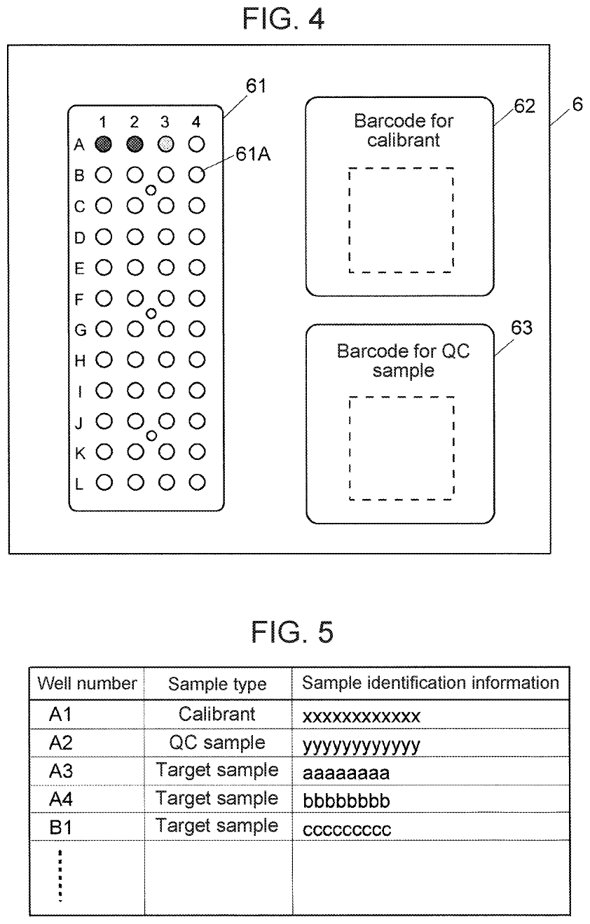

First, when the operator performs a predetermined operation on the operation unit 3, the control/processing unit 2 receiving this operation activates the sample information registration support unit 20. In the sample information registration support unit 20, the information registration support screen creation unit 200 creates a sample information registration support screen 6 in which, for example, a plate plan view 61 as a plan view of one sample plate as shown in FIG. 4 is arranged, and displays it on the screen of the display unit 5 through the display processing unit 24 (step S1).

As shown in FIG. 4, on the sample information registration support screen 6, in addition to the plate plan view 61, a calibrant barcode 62 and a QC sample barcode 63 set in advance are also arranged. However, since the calibrant barcode 62 and the QC sample barcode 63 are not always necessary, they can be appropriately displayed according to a predetermined operation by the operator. Further, multiple types of calibrants and QC samples may be used, and in that case, two or more calibrant barcodes 62 and QC sample barcodes 63 may be displayed respectively. Each of the calibrant barcode 62 and the QC sample barcode 63 has sample information as data, including information indicating the type of sample such as calibrant or QC sample, and information capable of identifying the sample such as a sample name, an included compound name, and an identification number for each of the calibrant and QC sample. A barcode having sample information as data can be set in advance by, for example, an analysis manager. The barcode here includes a two-dimensional code such as a QR Code (registered trademark).

Note that when using an identifier whose data amount is limited like a one-dimensional barcode, the identifier itself does not have all the sample information, but detailed sample information associated with the data indicated by the identifier can be stored in a storage unit included in or external to the control/processing unit 2.

In a state where the sample information registration support screen 6 is displayed, when the operator performs a predetermined operation on the operation unit 3 (or automatically without performing an operation), the information input receiving unit 201 visually clarifies one well 61A that is a target for receiving input of sample information next on the plate plan view 61 (step S2). For example, on the plate plan view 61, the position of the well 61A can be presented to the operator by displaying a portion corresponding to one well 61A, which is a target for receiving input of sample information, in a predetermined color different from others, or by blinking the display. In addition to such display, for example, a sound may be used to draw the operator's attention.

The operator confirms the position (number) of the well 61A on the plate plan view 61, and using the barcode reader 4, performs a reading operation to read a barcode corresponding to a target sample, a calibrant, or a QC sample to be formed in the actual well 102 corresponding to the instructed well 61A (step S3). The barcode corresponding to the target sample can be, for example, one attached to a container such as a petri dish or a vial in which the target sample is accommodated. For a target sample, the information for identifying the sample can be, for example, a sample name, an identification number, or the like. On the other hand, the barcodes corresponding to the calibrant and the QC sample are the calibrant barcode 62 and the QC sample barcode 63 displayed on the sample information registration support screen 6 described above. That is, in this system, sample information can be input for any of the target sample, the calibrant, and the QC sample by a single operation of exactly the same procedure called a barcode reading operation.

In routine analysis where a large number of target samples are analyzed, usually, the positions of the wells 102 where calibrants and QC samples are formed are predetermined, and the operator may proceed with the work according to those rules. On the other hand, in non-routine analysis, there are often no such prior rules, and according to the purpose of the analysis, the type of samples, and the like, the operator often freely decides the positions of the wells 102 where target samples, calibrants, and QC samples are formed.

When the operator performs the barcode reading operation, the information input receiving unit 201 receives the read barcode information, and the information registration processing unit 202 registers the sample information included in or associated with the barcode in association with a well number (for example, A1, A2, . . . in the example of FIG. 4) indicating the position of the well 102 at that time (step S4). Note that if the operator mistakenly reads an inappropriate barcode, the input by that reading can be canceled by performing a predetermined operation.

When the registration of sample information for one well 61A is finished, the operator drops a target sample, a calibrant, or a QC sample corresponding to the registered sample information into the corresponding well 102 on the actual sample plate 101 (step S5). When a sample and a matrix are mixed on the sample plate 101, a matrix solution is also dropped after dropping the sample, and they are mixed. On the other hand, when the sample and the matrix solution are mixed in advance, the mixed solution may be dropped into the well.

Thereafter, when the operator performs a predetermined operation on the operation unit 3, the information input receiving unit 201 changes the display color of the well 61A, for which sample information has been registered and the sample has been actually dropped, to a predetermined color in the plate plan view 61 of the sample information registration support screen 6 (step S6). Then, if a last well according to the prescribed order on one sample plate has been reached, the work is determined to be finished (Yes in step S7), and otherwise, the process returns to step S2. When returning to step S2, the information input receiving unit 201 instructs the operator on the display to register sample information for a next well 61A according to the prescribed order on the plate plan view 61.

The order of instructing wells 61A for which sample information should be registered on the sample plate 101 is predetermined, and all wells 61A are sequentially instructed on the plate plan view 61. At this time, the dedicated calibrant wells are excluded, but all wells including the dedicated calibrant wells may be sequentially instructed.

By repeating the above steps S2 to S7, registration of sample information and dropping of actual samples are performed for all wells 102 on the sample plate 101. Of course, since there may be a choice not to mount a sample (not use the well) for some wells 102, when the operator performs a predetermined operation, the well 61A automatically instructed on the plate plan view 61 may be passed to proceed to a next well 61A for which sample information should be registered. Then, when dropping of samples into the wells 102 on one sample plate 101 is finished, the sample plate 101 is provided for air-drying treatment (step S8), and preparation of samples that can be analyzed by the MALDI-MS system is finished.

In the information registration processing unit 202 of the sample information registration support unit 20, a table in which well numbers are associated with sample information including sample types and information for identifying samples as shown in FIG. 5 is created, and this information is stored. At the time of executing analysis, the positions of calibrants and QC samples are identified based on this information, and calibration processing of m/z values is performed based on the analysis results performed on the calibrants. Note that when analyzing a plurality of samples formed on the sample plate 101, analysis is executed for each sample one by one, but the order of analysis at that time does not necessarily have to be the same as the order at the time of sample information registration described above.

As described above, in the MALDI-MS system of the present embodiment, the positions of target samples, calibrants, QC samples, etc. can be freely decided for a plurality of wells 102 on the sample plate 101. Therefore, for example, even in a case where one calibrant is arranged for every n target samples for an arbitrary number n, all or most of the wells 102 can be effectively utilized. Further, for any of the target sample, the calibrant, and the QC sample, sample information can be easily input by the same procedure of operation using a barcode, so that workability is good and input errors of sample information can be reduced.

Note that in the above description, the barcodes corresponding to the calibrant and the QC sample were displayed on the screen, but the barcodes may be provided to the operator by a method other than display. Specifically, they may be provided to the operator as printed matter.

Further, in the above embodiment, a barcode including a two-dimensional code was used as an identifier, but as described above, the identifier is not limited to a barcode as long as it is an identifier that can be used in common for target samples, calibrants, and QC samples, and for example, other identifiers such as an IC tag, also called an RFID tag or RF tag, may be used. In that case, since IC tags corresponding to calibrants and QC samples cannot be provided through a display screen, they can be provided to the operator in the form of, for example, a card. Further, as the reading device, it is natural to use a reader matched to the format of the IC tag, such as an RFID reader.

Further, in the above embodiment, on the displayed plate plan view 61, a well for which sample information is to be registered next, a well in a state where sample information has already been registered and a sample has also been dropped, and a well for which sample information has not yet been registered are displayed in, for example, different colors so as to be visually distinguishable. In addition to this, in a well in a state where sample information has already been registered and a sample has also been dropped, the display colors may be made visually distinguishable from each other by changing the display color or the like according to what type the sample is, that is, whether it is a target sample, a calibrant, or a QC sample. Thereby, the operator can confirm the type of sample already registered at a glance.

In addition, the above embodiment is merely an example of the present invention, and it is natural that appropriate modifications, corrections, additions, etc. within the scope of the gist of the present invention are included in the scope of the claims of the present application.

Specifically, in the MALDI-MS system of the above embodiment, target samples, calibrants, and QC samples were assumed as sample types, but a common sample may be used for a calibrant and a QC sample. Further, as described above, one or both of a calibrant and a QC sample may be used in multiple types. Furthermore, other sample types may be provided. For example, when performing a comparative analysis between a reference sample and a target sample, it is conceivable to provide one or more reference samples separately from calibrants and QC samples.

### Various Aspects

It will be understood by those skilled in the art that the exemplary embodiments described above are specific examples of the following aspects.
(Item 1) One aspect of the analysis work support program for a laser desorption ionization mass spectrometer according to the present invention is a program for supporting registration of information regarding samples upon analysis in a laser desorption ionization mass spectrometer capable of sequentially executing analysis on samples prepared in advance in a plurality of wells on a sample plate, the program causing a computer to function as:
a well presentation function unit that presents the plurality of wells on the sample plate one by one to an operator in a prescribed order;
an information acquisition function unit that, in a state where one well is presented by the well presentation function unit, receives sample information obtained by a reading operation using a reading device by the operator with respect to an identifier that has sample information including information indicating a sample type for one sample and information for identifying the sample under the sample type or that is associated with the sample information; and
an information registration function unit that registers the sample information received by the information acquisition function unit in association with identification information of the well that was being presented when the reading operation was performed.
(Item 7) Further, one aspect of the sample preparation method according to the present invention is a method for preparing a sample using the analysis work support program for a laser desorption ionization mass spectrometer according to Item 1, the method executing: an identifier reading step in which the operator performs a reading operation to read an identifier that has sample information for one sample or is associated with the sample information using a reading device according to the position of the well presented by the well presentation function unit;
an information registration step of registering the sample information included in or associated with the identifier read in the identifier reading step in association with identification information of the well that was being presented when the reading operation was performed; and
a sample formation step of forming a sample corresponding to the sample information in the well on the sample plate where the sample information has been registered in the information registration step.
(Item 2) In the analysis work support program for a laser desorption ionization mass spectrometer according to Item 1 and the sample preparation method according to Item 7, the sample type can include at least two types among a target sample to be analyzed, a quality control sample, and a calibrant.

According to the analysis work support program for a laser desorption ionization mass spectrometer according to Item 1 and the sample preparation method according to Item 7, a well at an arbitrary position among a plurality of wells on a sample plate can be used as a well for forming, for example, not only a target sample but also a calibrant or a quality control sample. Therefore, on the sample plate, the degree of freedom in the positions of wells for forming target samples, calibrants, quality control samples, etc. increases, and it becomes possible to effectively utilize the wells on the sample plate. Thereby, the sample plate can be utilized without waste, and running costs for analysis can be saved.

Further, according to the analysis work support program for a laser desorption ionization mass spectrometer according to Item 1 and the sample preparation method according to Item 7, sample information including information indicating a sample type such as, for example, a calibrant or a quality control sample and information for identifying the type of calibrant or the like such as, for example, a compound name can be input by a single input operation, and sample information for samples of different types can be input by the same operation procedure. Thereby, the workability of sample information registration and sample preparation is improved, and the occurrence of work errors such as input errors of sample information is reduced, so that accuracy in the correspondence between samples formed in wells and sample information can be ensured. As a result, the reliability of analysis can also be improved.
(Item 3) In the analysis work support program for a laser desorption ionization mass spectrometer according to Item 1 or 2, the identifier can be a barcode including a two-dimensional code, and the reading device can be a barcode reader.

According to the analysis work support program for a laser desorption ionization mass spectrometer according to Item 3, information included in an identifier can be read by a simple operation. Further, the cost of the device can be low.
(Item 4) In the analysis work support program for a laser desorption ionization mass spectrometer according to Item 3, the computer can be further caused to function as an identifier display function unit that displays a barcode having sample information for a quality control sample and/or a calibrant or associated with the sample information on a display screen.

Usually, sample information for a target sample differs for each individual sample. Therefore, a barcode including sample information for a target sample can be provided accompanying the sample, for example, by being attached to a container in which a sample serving as a source of the target sample is accommodated. In that case, the operator may read such a barcode with a barcode reader. On the other hand, in the analysis work support program according to Item 4, since a barcode including sample information for a calibrant or a quality control sample is displayed on the screen, the operator may read the displayed barcode with a barcode reader.

Thus, according to the analysis work support program according to Item 4, sample information for a calibrant or a quality control sample can be registered only by performing a reading operation with respect to a barcode displayed on the screen, and the operator's work can be simplified to improve work efficiency.
(Item 5) In the analysis work support program for a laser desorption ionization mass spectrometer according to any one of Items 1 to 4, the computer can be further caused to function as a registration information presentation function unit that displays a plan view of a sample plate showing an arrangement of a plurality of wells on a display screen and shows wells for which sample information has been registered in different colors for each sample type.

According to the analysis work support program according to Item 5, the operator can, for example, accurately grasp the positions of wells where target samples, calibrants, and quality control samples have been registered at a glance on the display screen. Thereby, for example, after registering sample information for a certain well in response to a barcode reading operation or the like, it is possible to easily grasp whether or not the registered sample was an intended sample type, for example, whether or not a calibrant was surely registered when sample information for a calibrant was registered.
(Item 6) In the analysis work support program for a laser desorption ionization mass spectrometer according to Item 5, the well presentation function unit can show a well for which sample information should be registered next in a visually identifiable manner in the plan view of the sample plate displayed by the registration information presentation function unit.

According to the analysis work support program according to Item 6, the operator can accurately grasp the position of the well for which sample information should be registered next visually on the screen.

### REFERENCE SIGNS

1 . . . Measurement unit
10 . . . MALDI ion source
100 . . . Sample stage
101 . . . Sample plate
102 . . . Well
110 . . . Laser irradiation unit
11 . . . Mass analysis unit
2 . . . Control/processing unit
20 . . . Sample information registration support unit
200 . . . Information registration support screen creation unit
201 . . . Information input receiving unit
202 . . . Information registration processing unit
22 . . . Analysis control unit
23 . . . Data processing unit
24 . . . Display processing unit
3 . . . Operation unit
4 . . . Barcode reader
5 . . . Display unit

1. An analysis work support program for a laser desorption ionization mass spectrometer for supporting registration of information regarding a sample upon analysis in a laser desorption ionization mass spectrometer capable of sequentially executing analysis on samples prepared in advance in a plurality of wells on a sample plate, the program causing a computer to function as:
a well presentation function unit that presents the plurality of wells on the sample plate one by one to an operator in a prescribed order;
an information acquisition function unit that, in a state where one well is presented by the well presentation function unit, receives sample information obtained by a reading operation using a reading device by the operator with respect to an identifier that has sample information including information indicating a sample type for one sample and information for identifying the sample under the sample type or that is associated with the sample information; and
an information registration function unit that registers the sample information received by the information acquisition function unit in association with identification information of the well that was being presented when the reading operation was performed.

2. The analysis work support program for a laser desorption ionization mass spectrometer according to claim 1, wherein the sample type includes at least two types among a target sample to be analyzed, a quality control sample, and a calibrant.

3. The analysis work support program for a laser desorption ionization mass spectrometer according to claim 2, wherein the identifier is a barcode including a two-dimensional code, and the reading device is a barcode reader.

4. The analysis work support program for a laser desorption ionization mass spectrometer according to claim 3, further causing the computer to function as an identifier display function unit that displays a barcode having sample information for a quality control sample and/or a calibrant or associated with the sample information on a display screen.

5. The analysis work support program for a laser desorption ionization mass spectrometer according to claim 1, further causing the computer to function as a registration information presentation function unit that displays a plan view of a sample plate showing an arrangement of a plurality of wells on a display screen and shows wells for which sample information has been registered in different colors for each sample type.

6. The analysis work support program for a laser desorption ionization mass spectrometer according to claim 5, wherein the well presentation function unit shows a well for which sample information should be registered next in a visually identifiable manner in the plan view of the sample plate displayed by the registration information presentation function unit.

7. A sample preparation method using the analysis work support program for a laser desorption ionization mass spectrometer according to claim 1, executing:
an identifier reading step in which the operator performs a reading operation to read an identifier that has sample information for one sample or is associated with the sample information using a reading device according to the position of the well presented by the well presentation function unit;
an information registration step of registering the sample information included in or associated with the identifier read in the identifier reading step in association with identification information of the well that was being presented when the reading operation was performed; and
a sample formation step of forming a sample corresponding to the sample information in the well on the sample plate where the sample information has been registered in the information registration step.
